(19) United States
(12) Patent Application Publication
(10) Pub. No.: US 2007/0085903 A1
(43) Pub. Date: Apr. 19, 2007

(54) 3-d stereoscopic image display system

(75) Inventor: Guofeng Zhang, Shanghai (CN)

Correspondence Address: L. Howard Chen, Esq.;Kirkpatrick & Lockhart Preston Gates Ellis LLP, Suite 1700, 55 Second Street, San Francisco, CA, 94105, US

(73) Assignee: VIA Technologies, Inc.

(21) Appl. No.: 11/581,976

(22) Filed: Oct. 17, 2006

Related U.S. Application Data
(60) Provisional application No. 60/728,026, filed on Oct. 17, 2005.

(51) Int. Cl. H04N 15/00

(52) U.S. Cl. 348/58

(57) ABSTRACT

This invention discloses a system and method for displaying 3-D stereoscopic images, in which stereoscopic image data are processed separately by two graphic processing channels. The operation of the two channels is synchronized, so that the processed stereoscopic images are outputted simultaneously to be displayed either by a polarization system or a head-mounted LCD system. Such a display system allows a viewer's left eye to see only a left image and the right eye to see only the right image, yet seeing the same pair of stereoscopic images at the same time, to create a natural 3-D image illusion.

### CROSS REFERENCE

This application claims the benefits of U.S. patent application Ser. No. 60/728,026, which was filed on Oct. 17, 2005, and entitled “Use MultiGPU to do stereo rendering”.

### BACKGROUND

The present invention relates generally to a 3-D stereoscopic image display system using polarizing filters and glasses or head-mounted LCD for viewing 2D images on a screen to give the illusion of 3-D images.

Stereoscopic display creates a 3-D illusion with a pair of 2-D images, one for the left eye, and the other for the right, representing two perspectives of the same object, with a minor deviation similar to the perspectives that both eyes naturally receive in binocular vision. The viewer's brain merges the pair of images and extracts depth information from the slightly different images. The depth information is the basis for providing the viewer with the sense of a three dimensional (3-D) image. On the other hand, if the pair of images perceived by the two eyes is identical, then the brain will interpret it as a flat 2-D image.

There are many ways to separately display different images to both eyes in order to create the 3-D image. For example, the head-mounted display is one of the mechanisms that generate the 3-D effect. The user typically wears a helmet or a pair of glasses installed with two small liquid crystal displays (LCD) with magnifying lenses, one for each eye. Another way is to use liquid crystal (LC) shutter glasses that will let light go through in synchronization with the images on the screen using the concept of alternate-frame sequencing.

For the alternate-frame sequencing, a 3-D movie is first filmed with two cameras with different perspectives. Then the images are placed into a single strip of film in alternate order. In other words, there is a first left-eye image, then a corresponding right-eye image, then a next left-eye image, followed by a corresponding right-eye image and so on.

The film is then run at a predetermined speed such as 48 frames-per-second instead of the traditional 24 frames-per-second. An audience wears specialized LC shutter glasses having lenses that can open and close in rapid succession according to the required speed. The glasses also contain special radio receivers. The projection system has a transmitter that instructs the glasses to open and shut one of the glasses. That is, the left-eye glass opens with the right-eye glass shut when left-eye image is on the screen; and the right-eye glass open with left-eye glass shut when the right-eye image is on the screen.

LC shutter glasses system is generally used in home 3-D movie systems. For public venues, polarizing filter systems are a more popular solution. In a linearly polarized glass system, stereoscopic images are projected and superimposed onto a screen through orthogonally polarizing filters. A viewer wears a pair of orthogonally polarizing glasses. If the left-projector filter is a horizontally polarizing one, then the viewer's left-eye glass is a matching horizontally polarizing one, with a right-projector filter and a right-eye glass being vertically polarizing ones. As each filter only passes light, which is similarly polarized and blocks the orthogonally polarized light, each eye only sees one of the images, the 3-D effect is thus similarly achieved as in the LC shutter glass system. However, linearly polarizing glasses require the viewer to keep his head level, as a tilting of the viewing glasses will cause the images of the left and right channels to interfere with each other.

Circularly polarizing system can solve this problem, where two images are projected and superimposed onto the same screen through circularly polarizing filters of opposite handedness. The viewer wears eyeglasses which contain a pair of circularly polarizing glasses mounted in reverse handedness. Light that is left-circularly polarized is extinguished by the right-handed glass; while right-circularly polarized light is extinguished by the left-handed glass. The result is similar to that of stereoscopic viewing using linearly polarizing glasses, except the viewer can tilt his or her head and still maintain left and right image separation.

However, alternate-frame sequencing has drawbacks and limitations. First, only one eye can see an image at a time, and two eyes alternately see images. It is contradictory to the operation of the human visual system, where two eyes always see images at the same time. This may attribute to the adverse physical reactions including eyestrain, headaches and nausea experienced by some viewers when watching this kind of display for an extended period of time. Second, since each eye sees images only half of the time, the stereoscopic display is only half as bright if a normal projector is used. Third, in computer rendered graphics, it places quite a burden on the graphic processing unit (GPU), as GPU has to render twice as many images (both left and right images) for the stereoscopic display. Fourth, when displaying stereoscopic images on a computer monitor, the monitor's refreshing rate also has to be doubled to achieve the same result.

As such, what is needed is an improved system and method for processing stereo graphic images in separate channels and separately presented to the viewer's eyes at the same time to generate a natural 3-D illusion.

### SUMMARY

In view of the foregoing, this invention provides a method and system for displaying stereoscopic 3-D images with both left and right images displayed simultaneously.

A system according to one embodiment of this invention provides two independent graphic processing channels. Stereoscopic images are separately supplied to each channel, instead of alternate-frame sequenced, with the left image processed by a left channel and the right image processed by a right channel. The operation of both channels is synchronized, so that the stereoscopic images are presented to the display system at the same time.

The construction and method of operation of the invention, however, together with additional objectives and advantages thereof will be best understood from the following descriptions of specific embodiments when read in connection with the accompanying figures.

### BRIEF DESCRIPTION OF THE DRAWINGS

FIG. 1 presents a diagram showing an overview of a duo-channel stereoscopic 3-D image display system according to one embodiment of the present invention.

FIG. 2 is a component diagram showing a displaying stereoscopic 3-D image being implemented in the duo-channel projection system.

FIG. 3 shows sections of a duo-frame movie film for a duo-channel stereoscopic 3-D movie.

FIG. 4 shows a section of a traditional stereoscopic 3-D movie film employing an alternate-frame sequencing method.

FIG. 5 presents a simplified flow-chart of rendering command issuing in a computer graphics rendering system for stereoscopic display.

FIG. 6 presents a diagram showing components of a duo-channel pixel-based display system for stereoscopic 3-D image display according to another embodiment of the present invention.

FIG. 7 presents a diagram showing components of a duo-channel head-mounted display system for stereoscopic 3-D image display according to another embodiment of the present invention.

### DESCRIPTION

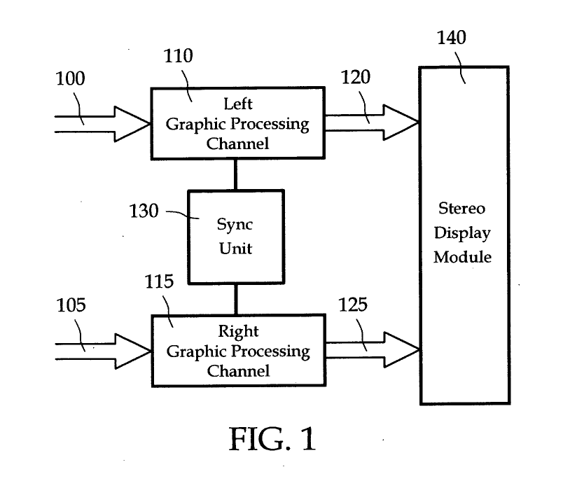

FIG. 1 presents a diagram showing an overview of a stereoscopic 3-D image display system according to one embodiment of the present invention, which includes two graphic processing channels—left 110 and right 115, a synchronizing unit 130 and a stereo display module 140. The two channels 110 and 115 separately process stereoscopic image data inputs 100 and 105, and output the processed image data 120 and 125 to the stereo display module 140, which let viewer's left eye see only left image 120, and the right eye sees only right image 125. The synchronizing unit 130 ensures that the same pair of stereoscopic images is sent simultaneously to the stereo display module 140, so that both eyes can see the same pair of stereoscopic images at the same time.

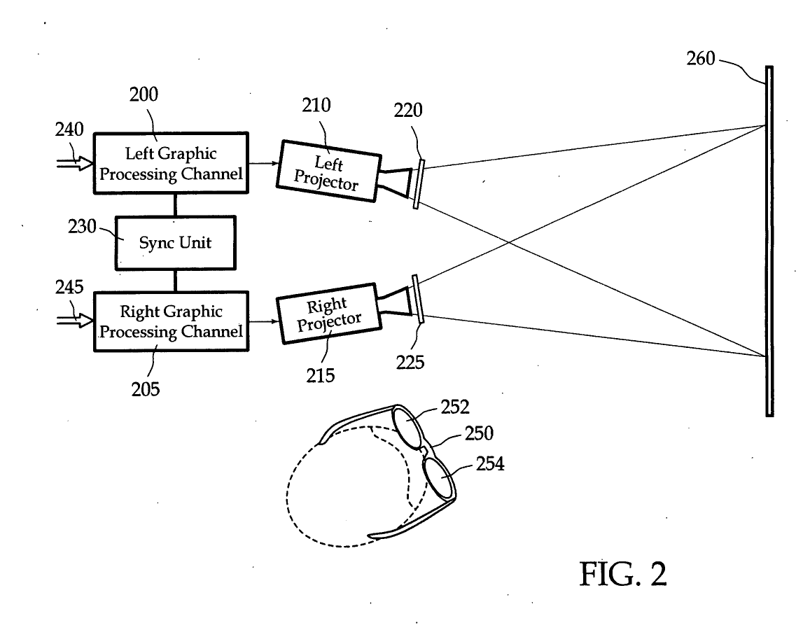

FIG. 2 is a further illustration of the aforementioned stereo display system having projectors 210 and 215, polarizing filters 220 and 225 of opposite polarization, screen 260 and viewer's polarizing glasses 250 with filters 252 and 254 of opposite polarization. Through polarizing filters 220 and 225 respectively, left and right images are projected and superimposed on the screen 260. A viewer must wear the pair of polarizing glasses 250 to view the stereoscopic 3-D image. The same side of the projector filter and viewing glass must have the same orientation of polarization, and two sides are opposite to each other. For instance, if the left-projector filter 220 and the left-polarizing glass 252 are vertically polarizing ones, then the right-projector filter 225 and the right-polarizing glass 254 are horizontally polarizing ones, and vice versa.

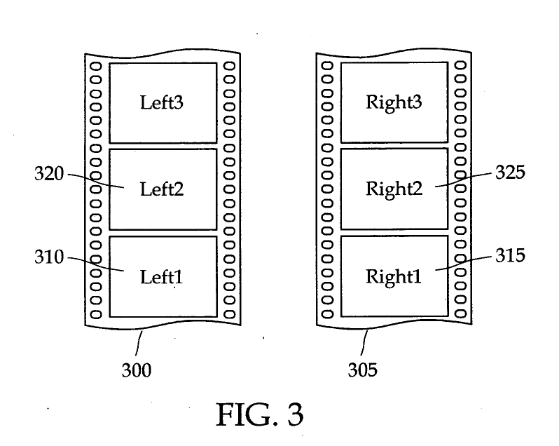

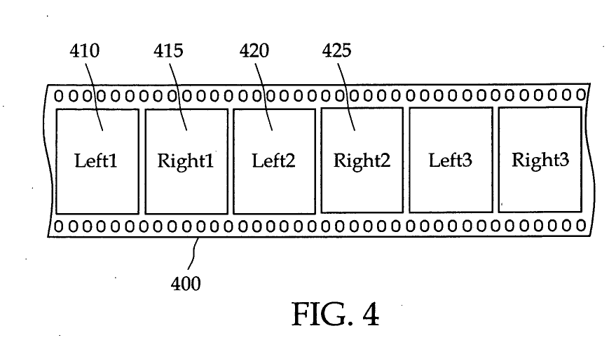

In case of projecting a movie film, the image data inputs 240 and 245 are films taken by a pair of stereoscopic cameras, they are kept in their original sequence as shown in FIG. 3, instead of being placed in an alternate-frame sequence as shown in FIG. 4. Then the graphic processing channels 200 and 205 are simply film reel machines. A synchronizing unit 230 could simply be a shaft of a motor where both reels are mounted on so that the two films are winded at the same speed.

In FIG. 3, frames 310 and 320, etc. on left film 300 are kept in their original sequence; so are frames 315 and 325, etc. on right film 305. Both films 300 and 305 are run simultaneously, so that the same pair of stereoscopic images is projected simultaneously on the screen. With the assistance of the polarization system, viewer's left eye can see only the left image and the right eye can see only the right image, but both eyes can see the same pair of stereoscopic images at the same time.

In FIG. 4, according to another embodiment of the present invention, frames 410 and 420, etc. are taken by a first camera, and frames 415 and 425, etc. are taken by another camera, but they are placed alternately on the same film 400 to form an alternate-frame sequence to be projected by a traditional single channel stereoscopic 3-D movie system.

Referring back to FIG. 1, for projecting computer rendered images, each graphic processing channel 110 or 115 includes at least one graphic processing unit (GPU) to render images from graphic input data 100 and 105. Left channel data 100 and right channel data 105 are processed independently, so that the load on the GPU is less than that in alternate-frame-sequencing systems where only one graphic processing channel has to process alternately both left and right channel data. Since both graphic processing channels 110 and 115 are run on the same system clock, which functions as a synchronizing unit 130, their outputs, i.e. computer rendered stereoscopic image pair, can be synchronized and sent simultaneously to the stereo display module 140.

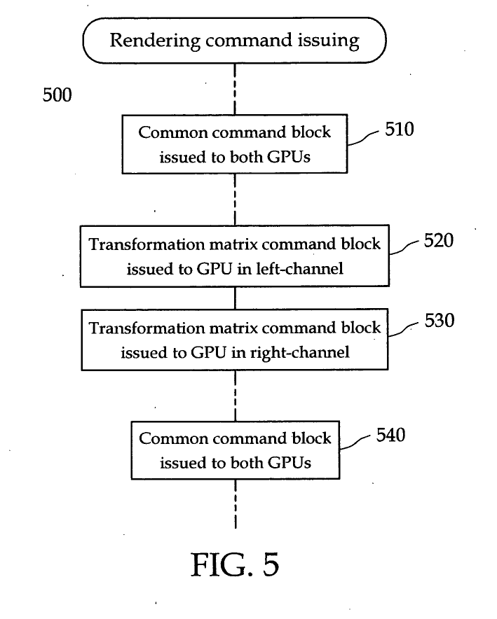

In the above rendering systems, differences between rendering a pair of left and right frames are only in transformation matrices, which are mathematical calculations in 2D or 3D transformation. So rendering commands for both channels are often identical, except for some predetermined values for certain variables or constants used for calculations. Often an application program can issue the same rendering commands to both channels at the same time. Only commands for sending transformation matrices, which are different for each channel, are issued separately to individual channels, as shown in FIG. 5, in which common command blocks 510 and 540 are commands identical for both channels, and they are issued to both channels at the same time. Command blocks 520 and 530 are for sending transformation matrices, so they are issued separately and carry certain data that is different from each other due to the difference between the rendered left and right images, with block 520 going to a left channel, and block 530 to a right channel. In this way, the computer system's central processing unit, or CPU, has less processing to do for issuing commands for this purpose, and also the related application program logics become simpler.

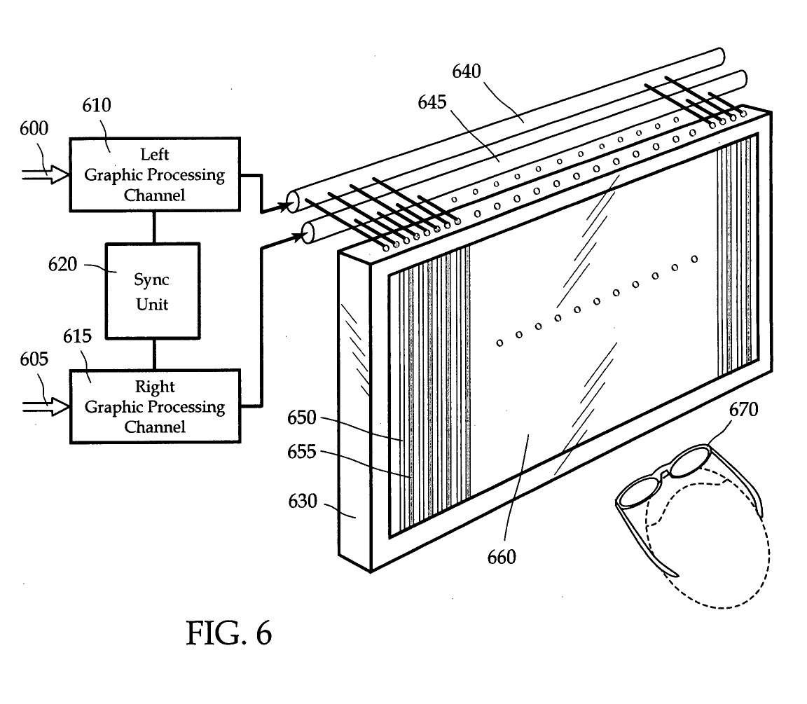

In systems where the stereo display system employs a pixel-based display device, such as liquid crystal display (LCD) or plasma display, as shown in FIG. 6, the column pixels are divided into two groups, odd columns 640 connects to left channel 610, and even columns 645 connects to right channel 615. In order to separate the stereoscopic image pair, and let the left eye view only the left image, and the right eye views only the right image, a polarizing system as aforementioned is also employed. The difference is that here an interlaced polarizing filter is attached to the display screen 660, with horizontally polarizing columns 650 placed at odd pixel columns 640, and vertically polarizing columns 655 placed at even pixel columns 645. With a viewer wearing polarizing glasses 670—left eye horizontally polarizing and left eye vertically polarizing, the viewer's left eye can see only left image 600 displayed by the odd column 640, and right eye can see only right image 605 displayed by the even column 645.

Based on the same principle, pixel rows instead of columns can be divided, and the polarizing screen is then interlaced horizontally. However, one drawback of this kind of stereo display system is that its display resolution drops by half, as the stereoscopic image pair is displayed side-by-side and interlaced, instead of superimposed as in a projection system.

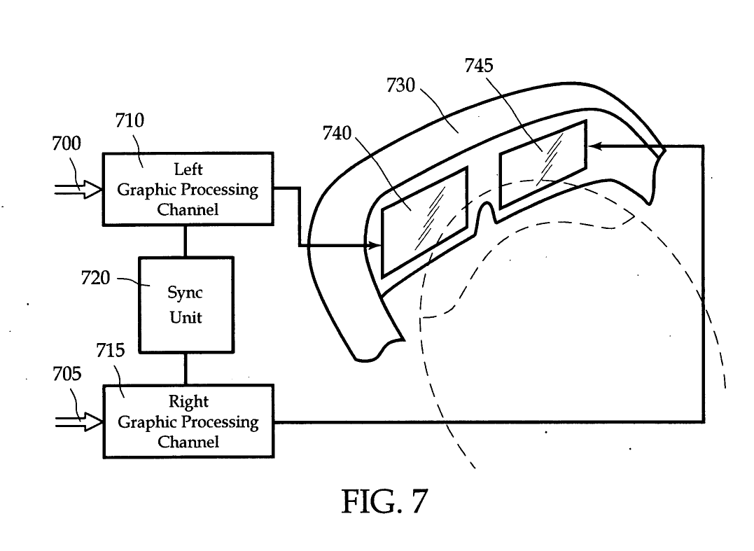

The stereo display system can also be embodied in a head-mounted display system as shown in FIG. 7, where a helmet 730 holds a pair of small liquid crystal displays (LCDs) 740 and 745. Since these small LCDs are held fairly close to the viewer's eyes, magnifying lenses are used, and one eye can only see one LCD. Here the left LCD 740 receives the left image 700 from the left graphic processing channel 710, and the right LCD 745 receives the right image 705 from the right graphic processing channel 715. Since the left and right images are already separately displayed to each eye, the stereoscopic 3-D image is displayed.

Although illustrative embodiments of this invention have been shown and described, other modifications, changes, and substitutions are intended. Specific examples of components and processes are described to help clarify the disclosure. These are, of course, merely examples and are not intended to limit the disclosure from that described in the claims. Accordingly, it is appropriate that the appended claims be construed broadly and in a manner consistent with the scope of the disclosure, as set forth in the following claims.

What is claimed is:

1. A stereoscopic 3-D image display system comprising:
at least two graphic processing channels for separately processing stereo image inputs;
a stereo display module receiving stereo images from the two graphic processing channels and presenting a left image only to a viewer's left eye and a right image only to the viewer's right eye; and
a synchronizing means connected to both graphic processing channels for synchronizing their image outputs.

2. The system as claimed in claim 1, wherein the graphic processing channel comprises at least one graphic processing unit for rendering computer graphic images.

3. The system as claimed in claim 1, wherein the stereo display module comprises a polarization unit to let viewer's left eye see only a left image and the right eye see only a right image.

4. The system as claimed in claim 3, wherein the polarization unit comprises a pair of polarizing filters of opposite polarizing orientations, and a pair of polarizing glasses also of opposite polarizing orientations, with the filter and glass on the same side sharing the same polarizing orientation.

5. The system as claimed in claim 1, wherein the synchronizing means provides a clock signal sent to both graphic processing channels for synchronizing the same.

6. The system as claimed in claim 1, wherein the stereo display module comprises:
a pixel-based display panel divided into odd pixel columns for displaying one channel of images, and even pixel columns for displaying the other channel of images;
an interlaced polarizing filter attached to the display panel with one polarizing orientation at the odd pixel column locations and orthogonally opposite polarizing orientation at the even pixel column locations; and
a pair of polarizing glasses also of orthogonally opposite polarizing orientations, with the filter and glass for the same side of the image sharing the same polarizing orientation.

7. The system as claimed in claim 1, wherein the stereo display module comprises:
a pixel-based display panel divided into odd pixel rows for displaying one channel of images, and even pixel rows for displaying the other channel of images;
an interlaced polarizing filter attached to the display panel with one polarizing orientation at the odd pixel row locations and orthogonally opposite polarizing orientation at the even pixel row locations; and
a pair of polarizing glasses also of orthogonally opposite polarizing orientations, with the filter and glass for the same side of image sharing the same polarizing orientation.

8. A stereoscopic 3-D image display system comprising:
at least two graphic processing channels for separately processing stereo image inputs;
a synchronizing module coupled to both graphic processing channels for synchronizing their image outputs; and
two eye-glass sized pixel-based display devices placed in front of viewer's eyes with the left side display device connected to the left channel, and the right side display device connected to the right channel.

9. The system as claimed in claim 8, wherein each graphic processing channel comprises at least one graphic processing unit for rendering computer graphic images.

10. The system as claimed in claim 8, wherein synchronizing means providing a clock signal sent to both graphic processing channels for synchronizing the same.

11. A method for displaying stereoscopic 3-D images comprising:
processing a pair of stereo images separately;
synchronizing the pair of stereo images; and
simultaneously displaying a left image of the processed stereo image pair only to a viewer's left eye and a right image only to the viewer's right eye.

12. The method as claimed in claim 11, wherein the processing further comprises:
generating graphics rendering commands;
issuing the commands to a two-channel computer graphics processing subsystem; and
rendering the pair of stereo images separately and simultaneously by the two channels of the graphics subsystem.

13. The method as claimed in claim 12, wherein the issuing further comprises:
issuing one or more commands common to both channels; and
issuing one or more commands different to each channel separately with predetermined different values for predetermined variables corresponding to the two stereo images.

14. The method as claimed in claim 11, wherein the displaying further comprises:
projecting the left and right images superimposed on a display medium; and
filtering the projected images with a pair of oppositely polarizing filters,
wherein the superimposed projected images are viewed through a pair of glasses of opposite polarization with the filter and glass on the same side sharing the same polarizing orientation.

15. The method as claimed in claim 11, wherein the displaying further comprises:
displaying the left image on a first group of column pixels, and the right images on a second group of column pixels in a pixel-based display device with columns of the first and second groups arranged alternately; and
filtering the pair of images with columns of polarizing filters respectively, with one polarizing orientation at locations of the first group of columns and the orthogonally opposite orientation at locations of the second group of columns,
wherein the interlaced images are viewed through a pair of glasses of orthogonally opposite polarization with the filter and glass for the same side of image sharing the same polarizing orientation.

16. The method as claimed in claim 11, wherein the displaying further comprises:
displaying the left image on a first group of row pixels, and the right images on a second group of column pixels in a pixel-based display device with rows of the first and second groups arranged alternately; and
filtering the pair of images with rows of polarizing filters respectively, with one polarizing orientation at locations of the first group of rows and the orthogonally opposite orientation at locations of the second group of rows,
wherein the interlaced images are viewed through a pair of glasses of orthogonally opposite polarization with the filter and glass for the same side of image sharing the same polarizing orientation.

17. The method as claimed in claim 11, wherein the displaying further comprises simultaneously sending the left image to a left pixel-based display device and the right image to a right pixel-based display device on a pair of glasses worn by a viewer.
